(19) United States
(12) Patent Application Publication
(10) Pub. No.: US 2017/0277778 A1
(43) Pub. Date: Sep. 28, 2017

(54) PERSONALIZED GUIDANCE AND RECOMMENDATION BASED ON MULTI-VARIABLE USER ATTRIBUTES AND MULTI-DIMENSIONAL SCHEMA

(71) Applicant: Maruthi Siva P Cherukuri, Lexington, MA (US)

(72) Inventor: Maruthi Siva P Cherukuri, Lexington, MA (US)

(21) Appl. No.: 15/470,788

(22) Filed: Mar. 27, 2017

Related U.S. Application Data
(60) Provisional application No. 62/313,395, filed on Mar. 25, 2016.

(51) Int. Cl. G06F 17/30; H04L 29/08; G06Q 30/02

(52) U.S. Cl. CPC G06F 17/30702; G06F 17/30528; G06F 17/3053; G06F 17/30554; G06F 17/30867; G06Q 30/0256; H04L 67/02; H04L 67/22; H04L 67/306; G06F 17/30522; G06F 17/30699; G06F 17/30861; G06F 17/30864; G06Q 30/02; G06Q 30/0241; G06Q 30/0251; G06Q 30/0255

(57) ABSTRACT

The present disclosure provides a system and method that recommends content to a user based on a compatibility between the user's interest and attributes of the content providers. Multiple contents may be aggregated based on the compatibility among the contents created by various user groups with varying intents or objectives. The present invention provides a search method where the system searches a database to gather information based on user interests and content attributes. A customization of search results are applied multi-dimensionally to customize the search result based on user interest and content compatibility. As such, the search results are personalized to meet the user's search objective.

### BACKGROUND

Field of the Invention

The present invention relates generally to a system and method for gathering or extracting information in a networked computerized environment. More particularly, the present invention relates to system and method for matching various types of users to provide information relative to each type of user's intent. In addition, the present invention relates to system and method that provides instructive information and marketing platform for the users.

Description of Related Art

It is common nowadays to use the Internet as a primary source of information. The amount of information being shared on the internet has seen rapid growth since the emergence of the internet. It is an effective channel of information for a user to search any information needed. As the number of users and amount of information grow, there have been attempts to organize the information and customize the information per user's preference. Most common attempt is to tag information with certain keywords.

Most of the search platforms provide keyword-based searches where results are presented to users based on certain order of relevancy. It is common to have the results of the searches be inaccurate to meet the specific intent of each user. Users, having different objectives in searching for the same topic, may receive the same result regardless of the differences in their objectives.

Therefore, what is needed is a system and method that provides more usability to a user when gathering information from a network or the Internet and a search result that encompasses user's search objective at a granular level. Also, what is needed is a computerized platform that enables match-making of multiple users with various intents in searching and sharing information in a networked information environment.

### SUMMARY

The subject matter of this application may involve, in some cases, interrelated products, alternative solutions to a problem, and/or a plurality of different uses of a single system or article.

The present invention overcomes the limitations of the prior art by providing a system and method for recommending a content most relevant to the user's search intent. An object of the present invention is to provide the users with contents compatible among different types of users.

Another objective of the present invention is to provide the user with customized search result that suits the user's search objectives.

Yet another objective of the present invention is to provide a search platform that enables multiple users to collaborate in receiving and providing contents, services, and products.

The present invention also helps assisting or guiding each user with its guidance interface or guidance pages. These guidance pages help an act of sharing among users efficient. In a non-limiting example, the guidance pages may be provided to the users based on a common interest or skills. Those subscribing to the common interest of skills may only get information related to such subscription through the guidance pages. The information may be sorted by the system according to the user's subscription and updated as more information relevant to the user's subscription is shared with the network provided by the present disclosure.

The guidance pages may feature functions such as, conversation, question and answers, stories and projects. Guidance page helps the authors or the users who are sharing information to:
Eliminate SEO keywords and keywords optimizations, because every page is pre-sorted according to the subscribed with skill/interest.
Come up with lot of pre-loaded templates, such as recipes and code tutorials, and the like.
Save time and effort for an author to write content, because the author can collaborate with other authors or use other author's work as a reference.
Connect users who are interested in the same or similar skill/interest to make better social recognition than unique visitors.

Accordingly, the present invention provides a system and method of matching data based on one or more users' objectives and interests. The present invention provides a computerized platform that associates users in different knowledge levels and differing objectives to provide a match making function.

In one aspect, a computer implemented method of identifying compatible content to a user is provided. The method may utilize a user device with one or more processors and a memory, in communication with a network. The method may begin with identifying, with an aggregation module in communication with the one or more processors, user interest. The user interest may indicate a topic of interest by a user.

Further, the method may continue with searching, with a search module in communication with the one or more processors, a database for a plurality of contents associated with the user interest. The plurality of contents may be provided by multiple content providers. A match analysis module, in communication with the one or more processors, may identify attributes of each of the multiple content providers and associate them with the plurality of contents. The match analysis module may compare the user interest with the attributes. The match analysis module may determine a compatibility between the user interest and the attributes based on a predetermined interest-to-attribute relation stored in the database. Finally, a recommendation module may suggest to the user via the user device, one or more of the plurality of contents based on the compatibility.

These and other objectives, features and advantages of the present invention will become apparent from the following detailed description of illustrative embodiments thereof, which is to be read in connection with the accompanying drawings.

### BRIEF DESCRIPTION OF THE DRAWINGS

FIG. 1 provides an exemplary schematic diagram of the system for providing compatible contents to multiple user types.

FIG. 2 provides exemplary steps involved in identifying compatible user groups based on the contents provided by each user group.

FIG. 3 provides an exemplary method for identifying compatible user groups based on the contents provided by each user group.

FIG. 4A provides another exemplary method for identifying compatible user groups based on the contents provided by each user group.

FIG. 4B provides another exemplary method for identifying compatible user groups based on the contents provided by each user group.

FIG. 5 provides a detailed exemplary schematic diagram of the system for providing compatible contents to multiple user types.

FIG. 6 provides a detailed exemplary schematic diagram of the system for providing compatible contents to multiple user types.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In referring to the description, specific details are set forth in order to provide a thorough understanding of the examples disclosed. In other instances, well-known methods, procedures, components, and materials have not been described in detail as not to unnecessarily lengthen the present disclosure.

It should be understood that if an element or part is referred herein as being “in communication with” or “connected to” another element or part, then it can be directly in communication with or connected to the other element or part, or intervening element(s) or part(s) may be present. When used, the term “and/or”, includes any and all combinations of one or more of the associated listed items, if so provided.

As used herein, the terms “communicate” and “communicating” refer to (1) transmitting, or otherwise conveying, data from a source to a destination, and/or (2) delivering data to a communications medium, system, channel, network, device, wire, cable, fiber, circuit, and/or link to be conveyed to a destination. The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list, or data presented in any other form.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Various operations may be described as multiple discrete operations in turn, in a manner that may be helpful in understanding embodiments; however, the order of description should not be construed to imply that these operations are order dependent.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

Some embodiments of the present invention may be practiced on a computer system that includes, in general, one or a plurality of processors for processing information and instructions, RAM, for storing information and instructions, ROM, for storing static information and instructions, a database such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

The system and method disclosed herein may comprise one or more computers or computerized elements, in communication with one another, working together to carry out the different functions of the system. The system and method disclosed herein may further comprise a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The system and method disclosed herein may comprise a computerized user interface provided in one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any type of computerized interfaces known in the art capable of allowing a user to input data and receive a feedback therefrom. The computerized user interface may further provide outputs executed by the system contemplated herein.

Database and data contemplated herein may be in the format including, but are not limiting to, XML, JSON, CSV, binary, over any connection type: serial, Ethernet, etc. over any protocol: UDP, TCP, and the like.

Computer or computing device contemplated herein may include, but are not limited to, virtual systems, Cloud/remote systems, desktop computers, laptop computers, tablet computers, handheld computers, smartphones and other cellular phones, and similar internet enabled mobile devices, digital cameras, a customized computing device configured to specifically carry out the methods contemplated in this disclosure, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, and PTP over IP networks (PTP/IP). In some embodiments, the network may comprise a cellular telephone network configured to enable exchange of data including, but not are not limiting to, textual data, audio data, video data, or any combination thereof.

Generally, the present invention concerns a system and method for providing compatible content to multiple user types. Traditionally, content searches are conducted based on keywords and/or tags. The present invention provides a computerized platform and methods that enables different types of users with varying objectives to find information that is most relevant to them. The system and method for providing compatible content compares and matches user interests and user attributes to identify information/material that is most relevant to their search objective. In particular, presently disclosed system and method identifies match makings between a user group that requires guidance information (instructive information, DIY material, and the like), a user group that provides content, and a user group that seeks target audience for sales of products/services.

The system for providing compatible contents to multiple user types may be implemented in hardware or a suitable combination of hardware and software. In some embodiments, the system may be a hardware device including processor(s) executing machine readable program instructions for analyzing data, and interactions between the components of the system. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors.

The processor(s) may include, for example, microprocessors, microcomputers, microcontrollers, digital signal processors, central processing units, state machines, logic circuits, and/or any devices that manipulate signals based on operational instructions. Among other capabilities, the processor(s) may be configured to fetch and execute computer readable instructions in a memory associated with the system for performing tasks such as signal coding, data processing input/output processing, power control, and/or other functions. The system may include modules as software units executing on a processor.

The system may include, in whole or in part, a software application working alone or in conjunction with one or more hardware resources. Such software applications may be executed by the processor(s) on different hardware platforms or emulated in a virtual environment. Aspects of the system, disclosed herein, may leverage known, related art, or later developed off-the-shelf software applications. Other embodiments may comprise the system being integrated or in communication with a mobile switching center, network gateway system, Internet access node, application server, IMS core, service node, or some other communication systems, including any combination thereof. In some embodiments, the components of system may be integrated with or implemented as a wearable device including, but not limited to, a fashion accessory (e.g., a wrist band, a ring, etc.), a utility device (a hand-held baton, a pen, an umbrella, a watch, etc.), a body clothing, or any combination thereof.

The system may include a variety of known, related art, or later developed interface(s) (not shown), including software interfaces (e.g., an application programming interface, a graphical user interface, etc.); hardware interfaces (e.g., cable connectors, a keyboard, a card reader, a barcode reader, a biometric scanner, an interactive display screen, etc.); or both.

The system for providing compatible contents to multiple user types may further include a memory for storing at least one of (1) a log of profiles of network devices, device owners, and associated communications including instructions, queries, conversations, data, and related metadata; (2) information related to one or more subscribers of a predefined service being provided by or implemented on a network; and (3) database schema including predetermined and updatable instructions, logics, and/or rules defining relationship between data types, for example, user type relationship, keywords relationship, and the like.

The system memory may comprise of any computer-readable medium known in the art, related art, or developed later including, for example, a processor or multiple processors operatively connected together, volatile memory (e.g., RAM), non-volatile memory (e.g., flash, etc.), disk drive, etc., or any combination thereof. The system memory may include one or more stored data repositories such as a stored data repository (also referred to as “database”), which may include a database and/or a file system that may be sub-divided into further databases and/or files for storing electronic files.

The system for providing compatible contents to multiple user types may be implemented as a standalone and dedicated device including hardware and installed software, where the hardware is closely matched to the requirements and/or functionality of the software. The system and the network appliance may be capable of operating as or providing an interface to assist exchange of software instructions and data among the components of the system.

The system for providing compatible contents to multiple user types, as described herein, may implement a server. The server may be implemented as any of a variety of computing devices, including, for example, a general purpose computing device, multiple networked servers (arranged in cluster or as a server farm), a mainframe, or so forth. The server may be installed, integrated, or operatively associated with the system. The server may store various data in its database. The server may include one or more modules, which enable the server being introduced to the network appliance. Examples of the network appliance include, but are not limited to, a DSL modem, a wireless access point, a router, a base station, and a gateway having a predetermined computing power and memory capacity sufficient for implementing the system described herein.

In a further embodiment, the device may be installed on or integrated with one or more devices such as various computing devices. For example, a smartphone or a tablet with an integrated camera may be implemented in the system to perform the functionalities of the system disclosed herein.

In a further embodiment, the system for providing compatible contents to multiple user types may be integrated with any number of devices in a distributed fashion, such as being integrated with or installed on communication devices, such as a smartphone.

System level architecture and data categorization. A system for providing compatible content to multiple user types is provided. The system may comprise user devices in communication with a query server, in turn in communication with the Internet having access to information available in the web. The user devices may be computing devices that is capable of being in communication with a network. Each of the user devices may provide a computerized interface for each user to provide user profile details. The user profiles may comprise user interests and a user attributes.

The system may comprise one or more processors, one or more databases, a web crawler, and one or more programs. The one or more programs may comprise instruction that, when executed, presents a user a search platform that gathers information based on the user profile by employing the methods described herein. Additionally, the above mentioned system may further comprise a network where multiple users may have access thereto using a computing device. The system may be connected to the internet.

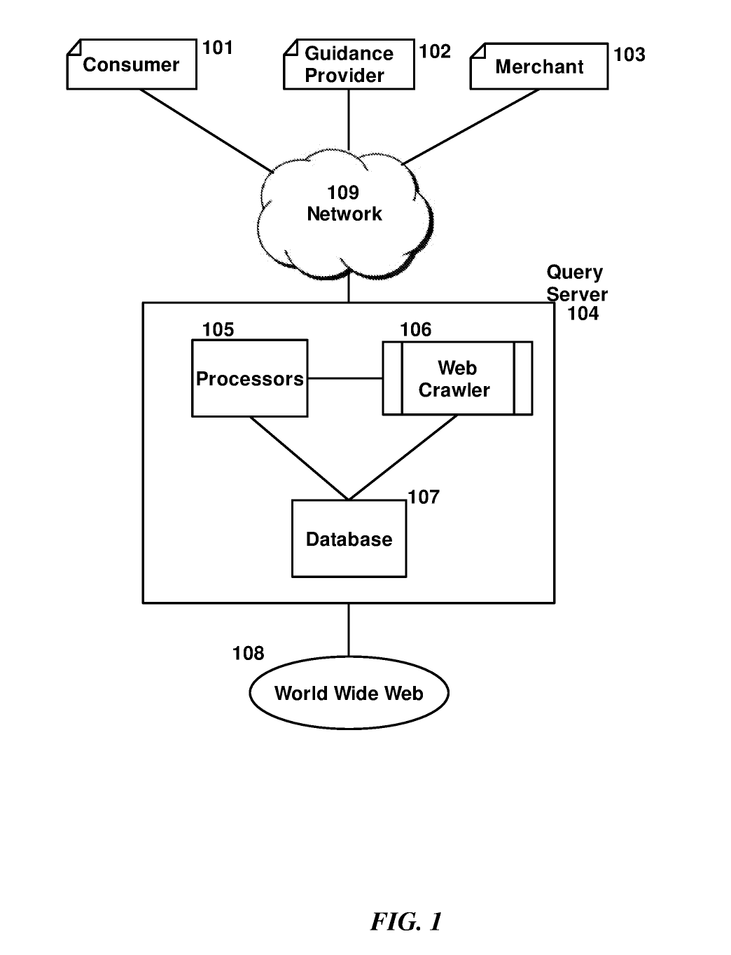

A system for providing compatible content to multiple user types is provided. The system presented herein represents a high-level architecture of system components and functions to carry methods presented herein. The system and method disclosed herein may be operable with one or more computing devices. The system may comprise a processor in communication with series of modules within a query server. FIG. 1 illustrates an exemplary embodiment of the present system in a networked environment. As shown in FIG. 1, the system for providing compatible content to multiple user types may comprise a query server 104 in communication with multiple user types (consumer 101, guidance provider 102, and merchant 103) via the network 109. In turn, the query server 104 may be in communication with the World Wide Web (i.e. internet) 108. The query server 104 may comprise one or more processors 105, web crawler 106, and a database 107. The database may store instruction and/or logics to perform the method provided herein. The web crawler 106 searches for information (herein also referred to as material) in accordance with the instructions and/or logics available by the database 107.

Commonly, web crawling is an automated and methodical process of gathering information from the Internet. This gathered data is then used by the initiating web crawler or search engine to create an index that can then be searched by a user through a web-based interface.

The system for providing compatible content to multiple user types may define types of users based on the user group's search intent and/or objective. Each of the defined user groups may be received by the user device and in turn by the system as users of the system completes inputting the user profile details via corresponding computerized user interfaces. Turning now to FIG. 1, the user types are defined as consumer 101, guidance provider 102, and merchant 103. The “consumer” user type 101 may be users who primarily utilizes the provided platform to receive information or to search information relative to their interests. The “guidance provider” user type 102 may be users who provides content. For example, those who writes blog articles, journals, lessons, how-to, and the like. Guidance providers 102 may be those who provide instructive and educational material (herein also referred to as “guidance”) helpful to the consumer 101. Guidance providers 102 generate contents to share with other users. The “merchant” user type 103 may be users who aims to utilize the system for providing services and products. Merchant user types 103 generate contents to be shared with an intent to sell/market. Users of the system for providing compatible content to multiple user types may engage in multiple user types available.

In some embodiments, the system provides a guidance and practice sharing platform that helps the users to improve their skills by identifying guidance from like-minded guidance providers, such as industry experts, professional, and friends. The system for providing compatible content to multiple user types enables a networking platform where the guidance providers and the consumers may communicate and interact with one another.

In some embodiments, the guidance provider may be subject matter experts in various fields of studies. The guidance provider may publish the information they like to share with the users, including the consumers, using the system provided herein. The information may be a goal-oriented material for the users to achieve certain tasks, goals, skills, and the like. The information provided by the guidance providers may be tagged or sorted according to the attributes of the guidance provider, such as occupation, experience level, expertise, and the like. The information from the guidance providers may be tagged or categorized per their attributes, such that the information can be matched to the consumers having related similar interest. Such categorizations, relationship definitions, and their compatibilities among the consumer's interests and guidance provider's attributes may be stored in the database.

Similarly, the merchant's attributes may be assigned to each merchant or identified by the merchant user type. Merchant attributes are similar to guidance provider attributes. Marchant attributes may include, pricing, experience level, certification, ratings, reviews, expertise, occupation, product information, service information, and the like. The merchant may publish information about the products and/or services they offer to be shared with the users of the system. The information may be a goal-oriented material for the users to achieve certain tasks, goals, skills, and the like. The information also may be related to guidance provided by the guidance providers. By way of an example, the merchant's information may include services and/or products that are recommended or required in the course of performing guidance shared by the consumer.

The user interest may be utilized for generating targeted marketing and advertisement of the merchant. Similar to the methods described above, the user may be a merchant who may suggest his or her product to another user based on another user's user interests, user attributes, and the like.

In some embodiments, the system may provide a platform for a market search. The system may be utilized to connect customers with products and/or services. The system tracks the users and their interests and gets the customer the content most relevant to their search intent and interest.

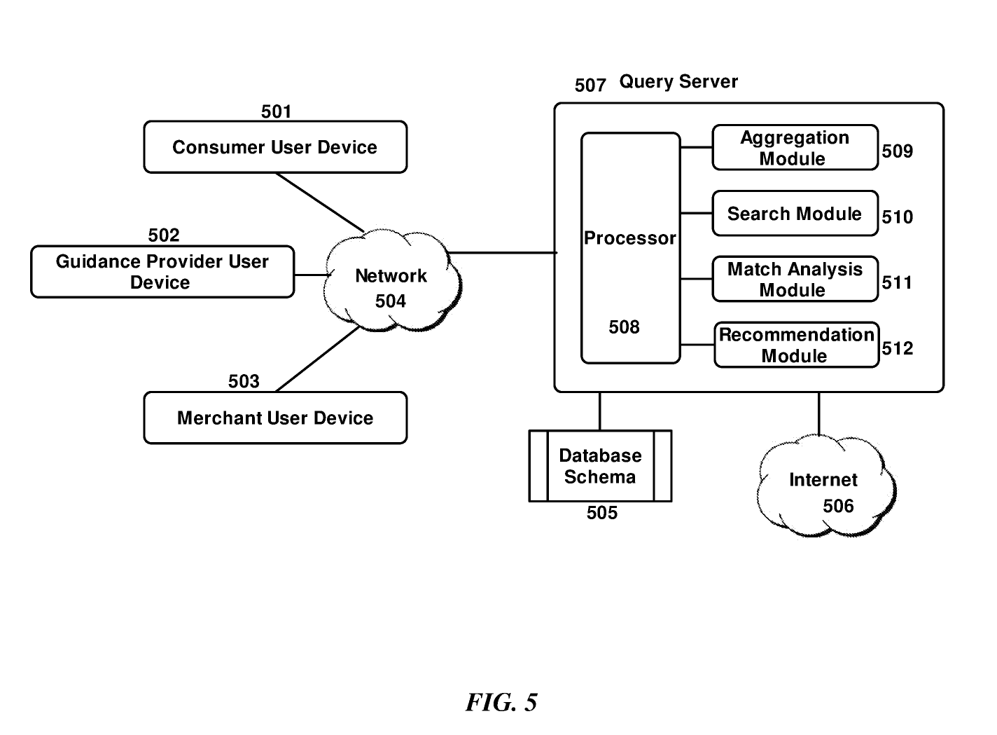

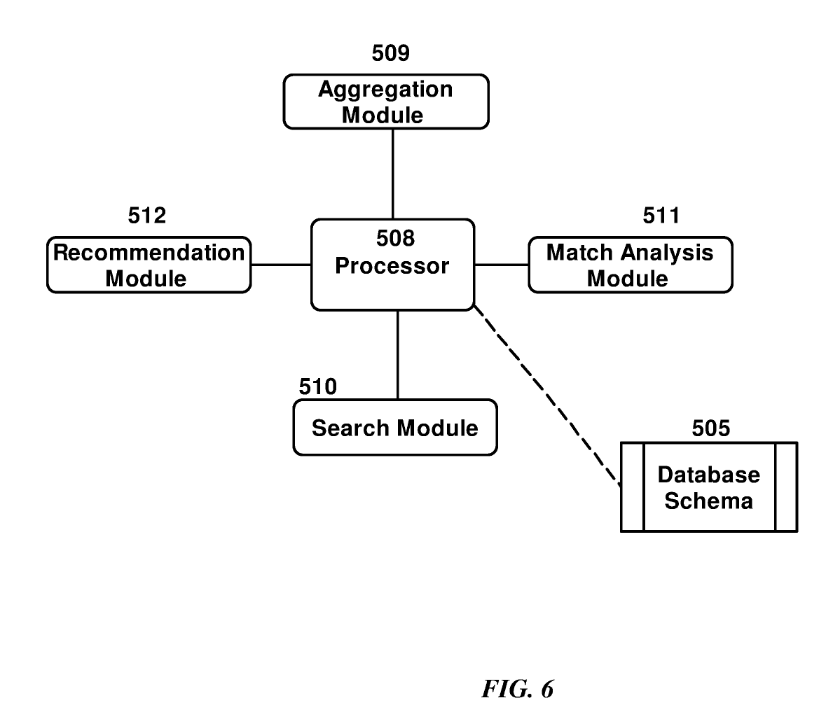

Modules. Now turning to FIGS. 5 and 6, the system for providing compatible content to multiple user types may comprise user devices, such as consumer user device 501, guidance provider user device 502, and merchant user device 503, in communication with the query server 507 via the network 504. The system may further be in communication with the database schema 505 and the internet 506. The query server 507 may comprise, inter alia, a processor 508 performing functions assigned to each of the modules, the aggregation module 509, the search module 510, the match analysis module 511, and the recommendation module 512. The processor 508 may be in communication with the internet 506 and a database schema 505. Further, a user may provide user type(s), user interest(s), and/or user attribute(s) using the user devices 501, 502, 503, to the query server via the network 504. In some embodiments, user interests and attributes may be obtained from information about the user available in the Internet (i.e. social network web sites).

The aggregation module 509 may be established with a bi-directional communication channels between the system and the users, where any type of user inputs and system outputs may be collected. The aggregation module 509 may identify the plurality of user interests and the plurality of user attributes. The aggregation module may further determine a scope of the search based on the user input (user interest, attribute, types, etc.) and the user's searched words, such that user's search intent is captured. In some embodiments, synonyms may be generated by a synonym module (not shown), such synonym information may be stored by the database. The search module 510 may process the user-inputted search words and search for available information in the Internet 506. The search module 510 identifies the user profile details (interests, attributes, user types, etc.) of the consumer (i.e. the searcher) and searches for information that is relative to such user profile details.

The match analysis module 511 may identify attributes assigned to the searched content. In some embodiments, the attributes of the content (i.e. guidance, merchant information) may be assessed based on the identification of the content provider (i.e. guidance provider and merchant provider). As such, the match analysis module 511 may identify attributes related to the search content and the interests related to the searcher/consumer. Further, the match analysis module 511 may identify the relevancy of the searched contents based on the interest-to-attribute (interest-to-guidance provider attributes and interest-to-merchant attributes) compatibility, closeness, relationship, and the like. Such predetermined definitions may be stored by the database schema 505.

Finally, the recommendation module 512 may be provided within the system which may suggest to the consumer the most relevant material from the searched content. The recommendation module 512 may push contents to the user based on the interests and attributes without the search words being provided by the user. The search module 510 may search the internet 506 for contents based on at least one of the plurality of interest and attributes.

A sorting module (not shown) may sort the plurality of search contents to identify a portion that contains at least one of the plurality of interest and/or attributes. Further, the sorting module may index the contents to a plurality of categories, where each of the plurality of categories is defined by each of the plurality of user attributes. The plurality of categories may have a hierarchical structure.

The ranking module may assign a rank to the contents based on a plurality of rank factors. The plurality of rank factors may include: a number of the at least one of the interests and/or attributes within the content; the compatibility between the interest and the attribute; the guidance provider's experience level and popularity; the merchant's experience level and popularity; each of a plurality of users relations; and the like, where the database schema contains the predetermined compatibility, relations, and the like among interests, attributes, user types, and user profiles.

The system of the present invention may define the scope of the search based on user's interest and attribute. The same keyword may be searched by multiple users, while each having different objectives and scopes of the search in mind. The present method of gathering data utilizes the user interests and user attributes to define the objective and intent of the search. The present system may provide user interfaces in a user's computing device where the user may create multiple profiles including the user interests and user attributes, the multiple profiles may be reflected, collectively or severally, to determine the search objective. The database schema stores and builds multi-dimensional relations among user profiles, consumer interests, guidance provider's attributes, merchant's attributes, and user types, in any combination thereof.

Initially, the search result may be found by a search module or a web crawler, then the system may process the search result to parse and present them into appropriate details based on the user interest, user attributes, goals, activities, and the like. Ultimately, the system may provide the same search results differently based on the user profile of each user requesting a search. Users may personalize sorting and ranking of the search result by assigning priority to their user interests and user attributes.

In some embodiments, a consumer may utilize the system for providing compatible content to multiple user types to find information offered by the guidance provider and/or the merchant by identifying matching interest-to-attribute. Similarly, a guidance provider may utilize the system to identify target audience (i.e. consumer with matching interests); to identify other guidance providers with similar interest and/or attribute; and to identify merchant with matching attribute (i.e. skills, expertise). Similarly, a merchant may utilize the system to identify target audience by identifying customer with matching attribute-to-interest; to identify guidance provider with matching attribute-to-attribute; and to identify guidance (content) with matching attribute-to-attribute.

In some embodiments, the system for providing compatible content to multiple user types may identify contents and products/services complimentary to one another. The match analysis module 511 may identify two or more contents by the guidance providers that matches the consumer's interest when combined. Similarly, the match analysis module 511 may identify two or more products/services, in combination, best matches the guidance (content) and/or the consumer's interest. Further, the match analysis module 511 may identify two or more of the either or both products/services and guidance that are complimentary to one another and best matches the consumer's interest and search intent. As a result, the recommendation module 512 may suggest the users (i.e. consumer) the combination of interest-matching guidance providers and merchants.

The user interests may be inputted by the user. The user interest may be of any topics that the user is interested in or any information that the user selects to gather from a search session. The user interest may be goal-oriented, for example “cooking” and “starting a business”. The user interest may be a personal interest. By way of example, the user interest may be a hobby such as “pets” or “dogs”. The user interest also may be a professional interest relating to the user's occupation or research. The user interest may have any form of words.

In one embodiment, the hierarchical link may be built among words (search words and interests) and pre-established in the database schema. The database schema contains, inter alia, logic that defines the hierarchical link among the words stored therein.

In another embodiment, the hierarchical link built may be assigned by the user. In yet another embodiment, the hierarchical link built may be learned by the system from observing the user's search history and web activity in the query server.

The database schema may further define relations among multiple users and their corresponding user interests and user attributes. In one embodiment, the relations between multiple users may be established by one of the multiple users initiating a search session. The relations between multiple users may include, but are not limited to, friend, mentor, coworker, or stranger. The one of the multiple users may assign such relations among the multiple users. The relations built among the multiple users may be stored in the database schema, and further be assigned with a value. The value may represent degree of priority of the relations built among the multiple users.

In another embodiment, the relations among the multiple users may be identified by the system from the user's web activity and search history. The web activity or search history may include any relations among the multiple users in a social websites or any other web activities that indicates relations among the multiple users.

In yet another embodiment, a plurality of user groups/types may have a hierarchical structure defined in the database schema. The database schema may define priority of the relation among user types by applying the hierarchical structure among the plurality of interest-attribute combinations. Alternatively, the user may define the hierarchical structure.

By way of examples, the system for providing compatible content to multiple user types enables writers (guidance providers) to collaborate with other writers to write a better content together in the form of mashup, resulting in a content rich in guidance quality/content quality. The system may also calculate the guidance cost based on number of authors and their expertise and each author's social following and influencing factors to sell the content to the other user types.

In some embodiments, the system may provide business opportunities to the content providers (guides) and the product/service providers as described above. The system may track the skills, interests, locations, products, services that the guide/content has. The system then identifies the author's skills and expertise based on their interactions with the system.

The system may detect the patterns of the authoring style and associate them with the attribute by either asking directly to author or based on author's interactions with the system. The patterns may include, their brand theme, style of writing, and vocabulary choices.

By way of an example, the system may find author an opportunity to provide their expertise as a service to the users by matching the attribute, such as experience level and occupation, with an interest of the user. The users may present requirements as interest to engage directly with merchants or guidance providers.

System may recommend users in different group types to one another based on their social connections. For example, users may have followed someone or been followed by someone who are interested in the content being provided or the activities of the user outside the system provided herein. Other examples are: friends who are interested in doing business; family connections; and the like.

In some embodiments, the system for providing compatible content to multiple user types may be applied in developing a business. The system may break the normal process flow for the businesses with product/service offered by the merchants to recommend collaboration with other organizations.

By way of an example, a business may host their product/service guide including product story, How-to, FAQ, product talks/chats, and the like as the content. A business can be the consumer type to request or who is interested in accomplishing business goals, such as customer discovery, sales, marketing, and the like. A business can use the guidance provided by the system which specifies how to do such activities and ask the questions to the guidance providers. The system may recommend interest-to-attribute matching products/services to consumers based on their interest.

A method for providing compatible content to multiple user types in accordance with the system described above is provided. The system may define a scope of the search based on a user interest. A user may set the user interest which may define the scope of the search being conducted by the system. The user interest may be stored in the one or more databases. In one embodiment, the computing device may provide the user a computerized user interface where a user may have access to define the user interest and user attribute. The following further describes exemplary embodiments of the operational environment and methods for providing compatible content to multiple user types.

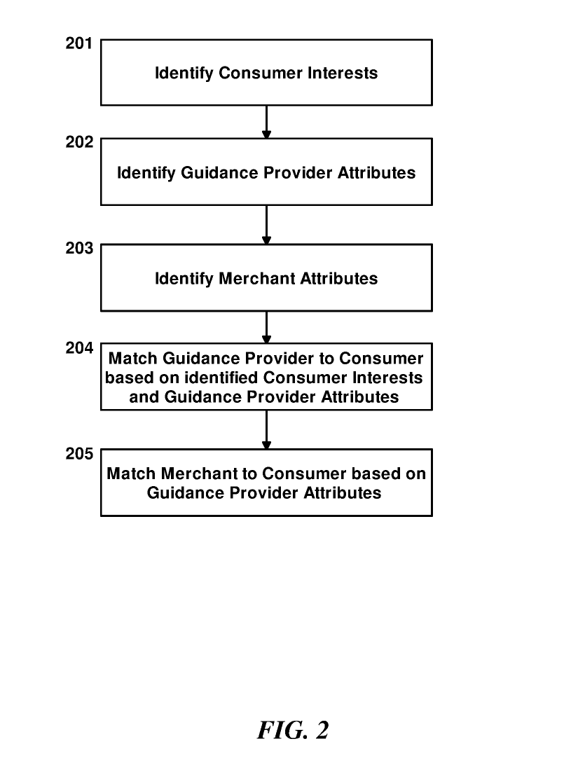

FIG. 2 illustrates exemplary steps for providing compatible content to multiple user types. In this embodiment, the system identifies consumer interests at step 201. The attributes of the guidance provider and the merchant are identified by the aggregation module as well at steps 202 and 203. At step 204, the match analysis module identifies a compatible guidance provider to the consumer based on a match between the consumer's interest and the guidance provider's attributes. With the consumer matched with the guidance provider, the match analysis module further identifies a merchant whose attributes matches the attributes of the selected guidance provider 205.

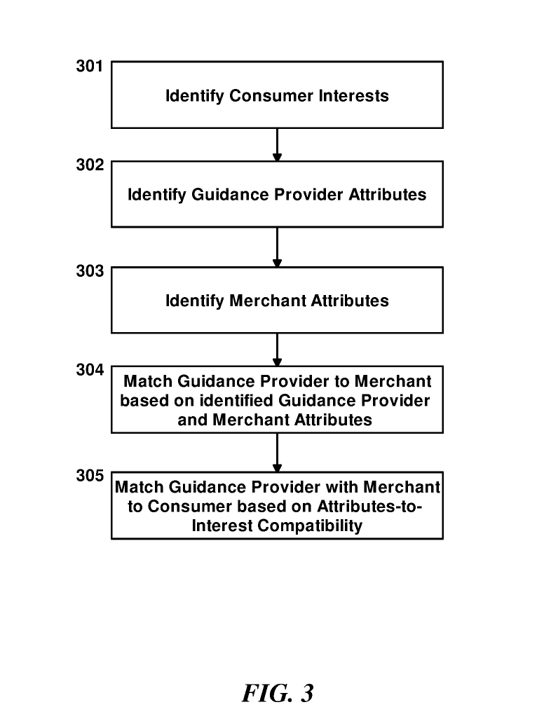

FIG. 3 illustrates another embodiment of steps for providing compatible content to multiple user types. In this embodiment, similar to the embodiment shown in FIG. 2, the system identifies consumer interests 302, guidance provider attributes 302, and merchant attributes 303, from multiple search results conducted based on search word inputted by the consumer. Once interests and attributes are identified, each of the search results are analyzed to detect its user group type, attributes, and interests. Each merchant is matched to the guidance providers based on a match between attribute-to-attribute 304. With the merchant-guidance provider match linked, the linked merchant-guidance that compliments one another is recommended to the consumer based on compatibility between the merchant-guidance and consumer interest 305.

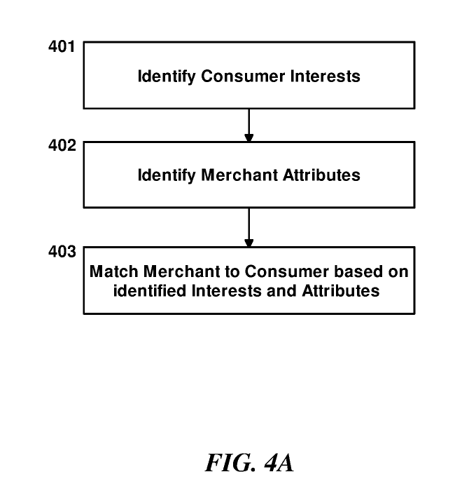

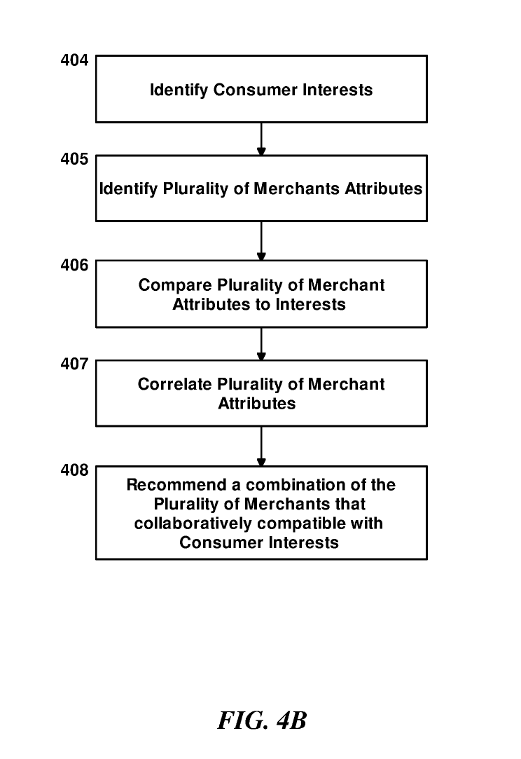

FIG. 4A illustrates the basic steps involved in matching merchant to consumer. The consumer interests and merchant attributes are identified at steps 401 and 402. At step 403, the system for providing compatible content to multiple user types identifies a compatible merchant to the consumer based on a match between consumer interests and merchant attributes.

FIG. 4B illustrates an exemplary embodiment of identifying a combination of multiple merchants that matches the user's interests. At step 404 and 405, consumer interest and merchant attributes of a plurality of merchants are identified by the system. Each of the plurality of merchant's attributes is compared with the consumer's interest to determine individual merchant compatibility with the consumer, 406. Once compared, each of the plurality of merchants are correlated to identify complimentary combinations of merchant attributes in comparison to the consumer's interest, at step 407. The recommendation module may suggest to the consumer the most compatible combination/collaboration of the merchants to the consumer's interests 408.

The following examples and case studies are presented to demonstrate the system and method provided herein. Various non-limiting embodiments of the present disclosure are provided.

Case studies and examples of the possible usage of the disclosed invention is provided herewith.

### Example 1

ABC Inc. has a goal to design a unique printer user interface.
1. The system identifies the next activity/interest is to “design unique interface for the printer”
2. It further identifies and determines the skills needed to do this activity.
3. It provides guidance in designing user interfaces.
4. It introduces a guidance provider, “Steve”, a user experience blogger, who created a guidance content.
5. It also connects with experienced users, such as professionals, based on the attributes, who can develop the ideas into at least 3 or 4 real product designs.
   If ABC Inc. tries to do something different, for example, designing a light weight printer, the system would have connected it with someone else, such as a hardware engineer who knows how to design a light weight mother boards. Theses match makings are done by comparing user interests (i.e. skills and goals) against attributes of different user types, namely content providers and product/service providers.

### Example 2

| Comparing Feature | Problem | The system Solution | Cost Comparison |
|---|---|---|---|
| Designing | No guidance | Clear guidance | This guidance costs little |
| printer | information | content identified | upfront money to save |
| | available in the | regarding how to | thousands of dollars to |
| | topics of | design prototypes | follow best practices and to |
| | designing | | avoid any pitfalls of ideation |
| | printer by the | | phase of the company |
| | product owner | | |
| | No access to | Experts/professionals | This professional guidance |
| | market | may be introduced | costs little upfront money to |
| | influencing | based on matching | save thousands of dollars |
| | designers to | attributes. | to follow best practices and |
| | provide | | to avoid any pitfalls of |
| | guidance (i.e. | | ideation phase of the |
| | instructive | | company |
| | materials) | | |
| | They should | They can hire as | The system provides |
| | have hired just | many as prototype | multiple designs instead of |
| | on prototype | specialists and size | just one design. |
| | specialist for | as they need | |
| | full time that | | |
| | cost $95k/year | | |
| Direct | The product | Since the nature of | (1) This saves the |
| customer | owners would | the system involves | consumer survey costs |
| access | spend hefty | networked | because the system |
| | money on tele | community, the users | connects direct potential |
| | marketing | can perform: | consumers who are |
| | surveys and | 1) Talk to potential | qualified people to ask. |
| | might or might | customers with a | (2) This saves the market |
| | not get enough | conversation to | research costs |
| | information. | understand pain | (3) This also confirms that |
| | | points | users need unique value |
| | | 2) Ask questions or | proposition because |
| | | surveys to | they are directly dealing |
| | | customers whose | with customers |
| | | profile closely | (4) Access to the customer |
| | | matches | demographics of who |
| | | 3) Write or read | has the information |
| | | consumer | |
| | | reviews/stories to | |
| | | understand more | |
| | | about the space | |
| | | 4) Provide contents | |
| | | based actionable | |
| | | guides to explain | |
| | | pain points | |
| | | without a certain | |
| | | product. | |
| Direct | Without the | Since the nature of | (5) This saves the |
| customer | system, this | the system involves | consumer survey costs |
| access for | market | networked | because the system |
| sales | research and | community, the | connects direct potential |
| enablement | survey would | customer base | consumers who are |
| of | be expensive | readily available and | qualified people to ask. |
| consumers | solution. The | they can do | (6) This saves the market |
| and | product owners | 5) Talk to potential | research costs |
| businesses | would spend | customers with | (7) This also confirms that |
| Direct | hefty money on | conversations to | users need unique value |
| customer | tele marketing | understand pain | proposition because |
| access | surveys and | points | they are directly dealing |
| | might or might | 6) Ask questions or | with customers |
| | not get enough | surveys to | (8) Access to the customer |
| | information or | customers whose | demographics of who |
| | direct access | profile closely | has the information |
| | with potential | matches | |
| | customers. | 7) Write or read | |
| | | consumer | |
| | | reviews/stories to | |
| | | understand more | |
| | | about the space | |
| | | 8) Write skill based | |
| | | actionable guides | |
| | | to explain pain | |
| | | points without a | |
| | | certain product. | |
| | Without the | The system provides | (1) This saves the viral |
| | system, they | the platform sales | marketing costs |
| | would have the | support channel | (2) This also confirms that |
| | support phone | where customers can | users need unique value |
| | numbers and | 1) Talk about the | proposition because |
| | support | product | they are directly dealing |
| | services fully | 2) Ask questions | with customers |
| | implemented | about the product | (3) Access to the customer |
| | which is | 3) Read product | demographics of who |
| | expensive. | stories | has the information |
| | | 4) Find product how- | |
| | | to | |
| | | 5) Learn more about | |
| | | the product | |
| | | 6) Interacting | |
| | | tutorials and | |
| | | videos | |
| | | 7) Product guides | |
| | | 8) Product manuals | |
| | | 9) Product tutorials | |
| | Without the | Product owners can | (4) This saves product |
| | system, there | write up the product | support costs for the |
| | will not be | guides or hire | product owner |
| | social | influencers as | |
| | references | explained above to | |
| | influencing on | write the instructive | |
| | direct | material, such as | |
| | consumers or | guides. | |
| | business | Users can write | |
| | | guides in some | |
| | | cases where product | |
| | | documentation or | |
| | | manuals is not clear | |
| | | from the product | |
| | | owner or | |
| | | manufacturer. | |
| | Without the | The system may be | |
| | system, sales | utilized as a sales | |
| | distribution | distribution channel. | |
| | must have its | It helps users sell the | |
| | own separate | product directly to | |
| | channel and | consumers and | |
| | sales enabling | businesses. | |
| | platform. | | |
| | Usually these | | |
| | partnerships | | |
| | takes a long | | |
| | time and need | | |
| | lot of effort to | | |
| | make every | | |
| | connection and | | |
| | deal. | | |
| Direct | Without the | Since the nature of | (9) This saves the |
| customer | system, this | the system involves | consumer survey costs |
| access for | market | networked | because the system |
| sales | research and | community, the | connects direct potential |
| enablement | survey would | customer base is | consumers who are |
| | be expensive | easily identified and | qualified people to ask. |
| | solution. The | the service/product | (10) This saves the |
| | product owners | providers can: | market research costs |
| | have to spend | 9) Connect to | (11) This also confirms |
| | hefty money on | potential to | that users need unique |
| | tele marketing | understand their | value proposition |
| | surveys and | pain points | because they are |
| | might or might | 10) Communicate | directly dealing with |
| | not get enough | with selected | customers |
| | information or | customer target | (12) Access to the |
| | direct access | based a match | customer demographics |
| | with potential | between the | of who has the |
| | customers. | customer's | information |
| | | interests and the | |
| | | product/service | |
| | | provider's | |
| | | attributes. | |
| | | 11) Write or read | |
| | | consumer | |
| | | reviews/stories to | |
| | | understand more | |
| | | about the market | |
| | | space | |
| | | 12) The | |
| | | product/service | |
| | | provider may | |
| | | provide | |
| | | actionable guides | |
| | | to demonstrate | |
| | | the | |
| | | product/service's | |
| | | features to the | |
| | | consumers. The | |
| | | actionable guides | |
| | | may be selected | |
| | | based on a match | |
| | | between the | |
| | | attributes and the | |
| | | interests. | |

### Example 3

ABC Inc. uses the system to input that they have idea about building the world's best looking printer (an activity/goal as “interest”). The system may identify information relative to ABC Inc., the information may be a guidance, an introduction to another user, a product, a service, and the like. The information being gathered undergoes a comparison to match the interest to attributes of the information and/or the information's origin.
1. Since, ABC Inc.'s unique value proposition is to “look different in the industry”
   a) It provides guidance in designing product user interface.
   b) It connects with professional guidance provider, “Steve”, a user experience blogger, who provides instructive content to the system.
   c) It also connects with user experience Professionals who can develop the ideas into at least 3 or 4 real product designs
2. The system also helps the ABC Inc. to get started on marketing.
   a) It provides a guidance for current market trends in the printer industry authored by a user “Mark”.
   b) It connects the user (ABC Inc.) with the content provider “Mark”, to help deciding initial beachhead market and Go-to market strategy
   c) It helps connecting other experts in the field for market researches.
   d) If ABC Inc. selects something other than a printer as the “interest”, the system connects the profile that is related to the interest of choice. The market reports and decision parameters change accordingly.
3. ABC Inc. has decided the beachhead market with the help of guidance in step 2, it moves the idea to a beta stage a sample product information.
   a) It provides guidance in producing quick and functional printer that meets the design given by step 1 and market needs decided by step 2
   b) It connects with professional guidance provider “John Smith”, a hardware engineer, who works independently and creates contents, i.e. guidance page and Helps, building hardware prototypes.
   c) It also connects with user experience Professionals who can develop the hardware prototypes into at least 3 or 4 real product designs
   d) If ABC Inc. tries to do something different than a prototype building, i.e. if it wants to build the real product which 3D printer right away, the system would have connected it with someone else like hardware engineer who knows how build massive scalable hardware products like printers
4. The system also helps the ABC INC. who is 3D to get started on marketing.
   a) The system finds people who are providing guidance in the market selected in step 2. It connects with the printer industry bloggers in fashion industry because most of the stylish consumer products need to be reviewed by fashion and home décor designers along with many other furniture, it also connects with bloggers in DIY market whose interested in 3D.
   b) It helps connecting other marketing bloggers and reviewers for Market validation purposes.
   c) If ABC Inc. selects something other than a printer, the system connects the profiles that is related to the industry of choice. As such, the market reports and decision interests/attributes change accordingly.
5. The system also helps ABC Inc. to get consumers who are interested in 3D printers by identifying the consumers who follow 3D printer's product reviews (reviewers) within the network.
   a) The system finds users who are following the reviews in the printer industry, fashion industry, home décor and DIY Industry—linking multiple interest types.
   b) If ABC Inc. selects something other than printer, the system connects the profiles that is related to the selected industry/interest/goal. And The market reports and decision parameters changes accordingly.
   c) If ABC Inc. selects non-consumer based products, then the system adds additional dimension to the matrix that whoever Business Customers and their respective representatives
6. ABC Inc. has successfully sold the ABC Inc.'s 3D printer samples and prototypes to 10 consumers. ABC Inc. want to develop a full-blown product with all the inputs that have taken from these initial 10 consumers.
   a) The system identifies the 10 consumers and provide guidance in developing hardware products and scale the manufacturing unit that meets the market demand based on the interests and attributes of the 10 consumers. Thus, the system identifies a trend in interest and attributes of a target consumer based on an analysis of the 10 consumers.
   b) It connects with a professional engineer “David”, a hardware engineering director (attribute: Occupation), who works independently and has a high level of experience (attribute: experience level).
   c) It also connects with other similar Professionals who can develop the hardware prototypes into products. Such professionals are identified based on a compatibility between interests and attributes among multiple user types.
   d) If ABC Inc. tries to do something different other than product development, like outsourcing to India or China right away, the system would have connected it with someone else with an experience in importing technology (attribute: Expertise) and how to outsource massive scalable hardware products like printers (attribute: Know-how).
7. The system also helps the ABC Inc. to get started on marketing.
   a) The system gathers all the data that it has successfully acquired consumers in step 4 and 5.
   b) The system runs the data patterns of how the product is being successfully sold on demographics, people interests, and their bios.
   c) It takes this formula and applies to provide guidance and connect with more influencers, bloggers and consumers
   d) It updates automatically with all the influencing parameters such as bloggers reviews on product home page or landing page with the updates directly from the system. This is the automated way where product owners save money without spending massive advertisement budgets on a traditional click-based advertisement services, such as Google Ads and Facebook Ads. This also saves IT costs for the ABC Inc.
   e) If ABC Inc. selects something other than printer, the system connects the profiles that is related to the selected industry/interest/goal. And The market reports and decision parameters changes accordingly.
   f) If ABC Inc. selects non-consumer based products, then the system add additional dimension to the matrix that whoever Business Customers and their respective representatives
8. The system also helps finally with full sales pipelines. ABC INC. can support directly on the system. The data gathered from marketing team in steps 4, 5, 6, 7 can be processed to identify the sales triggers along with the feedback received in step 8.,
   a) The system saves the consumer profile who purchased the printer and keeps the relationship and retention value life time. This is huge cost saving for the ABC Inc. otherwise ABC Inc. would have spent lot of time and money to save all consumer profiles in their databases.
   b) It helps connecting other sales representatives for these users to sell the product
   c) If ABC Inc. selects something other than printer, the system connects the profiles that is related to the selected industry/interest/goal. And The market reports and decision parameters changes accordingly.
   d) If ABC Inc. selects non-consumer based products, then the system add additional dimension to the matrix that whoever Business Customers and their respective representatives
9. ABC Inc. has utilized the system and its functions to implement a product development process. Now, it has to drive sales and marketing.
   a) It provides guidance in growth hacking the sales and marketing hardware products to create and tap the market
   b) It connects with professional marketing team “David” who writes the blog, The Hardware Marketing Agency, who works independently and writes guidance-type contents and helps building hardware manufacturing units.
   c) It also connects with other similar Professionals who can do sales and marketing of printer hardware.
   d) If ABC Inc. selects something other than a printer as interest/goal, the system identifies content providers' profiles that are related to the interest/goal. The market reports and decision parameters changes accordingly.
   e) If ABC Inc. selects non-consumer based products, then the system adds additional dimension (interest) to a search matrix, resulting in identifying compatible customers and other user types.
10. The system also helps the ABC Inc. with sales activities by identifying customers who needs 3D printers.
   a) The system has the data how it has successfully acquired consumers in step 1 through 9.
   b) The system runs the data patterns of how the product is being successfully sold by interrelating demographics, people interests, and their bios.
   c) It takes this formula and applies to business who are operating with these consumers and it finds the bloggers who work with these types of companies
   d) It connects these companies through influencers or bloggers reviews directly from the system. This is the automated way where product owners save money without spending massive marketing budgets and IT budgets.
   e) If ABC Inc. selects something other than printer, the system connects the profiles that is related to the selected industry/interest/goal. And The market reports and decision parameters changes accordingly.
   f) If ABC Inc. selects non-consumer based products, then The system add additional dimension to the matrix that whoever Business Customers and their respective representatives
11. The system also helps the ABC INC. to get started with sales deals with consumers who needs 3D printers
   a) The system has the data how it has successfully acquired consumers in step 1 thru 9.
   b) The system runs the data patterns of how the product is being successfully sold on demographics, people interests, and their bios.
   c) It takes this formula and applies to consumers whose interests matches with these consumers
   d) it finds the respective bloggers who work with these types of consumers
   e) It connects these consumers through influencers or bloggers reviews directly from the system. This is the automated way where product owners save money without spending massive advertising budgets and IT budgets.
   f) If ABC Inc. selects something other than printer, the system connects the profiles that is related to the selected industry/interest/goal. And The market reports and decision parameters changes accordingly.
   g) If ABC Inc. selects non-consumer based products, then The system add additional dimension to the matrix that whoever Business Customers and their respective representatives
12. ABC INC. has successfully SOLD the printer with the help77 of Guidance and professional resources from the system
   a) The system has the data how it has successfully acquired consumers in step 1 thru 12.
   b) The system runs the data patterns of how the product is being successfully sold on demographics, people interests, and their bios.
   c) It takes this formula and applies to consumers whose interests matches with these consumers and provides back to ABC INC. for further finding market gaps
   d) The system provides guidance from growth hackers and product pipeline designers to help ABC INC. for their next printer
   e) It connects these influencers or bloggers directly from the system. This is the automated way where product owners save money without spending massive consulting budgets to design the next product in pipeline.
   f) If ABC Inc. selects something other than printer, the system connects the profiles that is related to the selected industry/interest/goal. And The market reports and decision parameters changes accordingly.
   g) If ABC Inc. selects non-consumer based products, then The system add additional dimension to the matrix that whoever Business Customers and their respective representatives

### Example 4

| Comparing Feature | Problem | The system Solution | Cost Comparison |
|---|---|---|---|
| Developing | No Guidance | Clear Guidance Provided | This guidance |
| Hardware | Information. | How To Develop | costs little upfront |
| Printer | | Hardware Printer | money to save |
| | | Prototype | thousands of |
| | | | dollars to follow |
| | | | best practices and |
| | | | to avoid any |
| | | | pitfalls of ideation |
| | | | phase of the |
| | | | company |
| | No access to | They can even Hire | This professional |
| | market | Professionals to GET | guidance costs |
| | influencing | private guidance | little upfront |
| | designers to | | money to save |
| | provide | | thousands of |
| | guidance | | dollars to follow |
| | | | best practices and |
| | | | to avoid any |
| | | | pitfalls of ideation |
| | | | phase of the |
| | | | company |
| | They Should | They can hire as many as | For the money |
| | have hired just | prototype developers and | spend on $105K, |
| | on prototype | size as they need | they can multiple |
| | specialist for full | | prototypes instead |
| | time that cost | | of just one |
| | $105K/year | | prototype without |
| | | | The system |
| Market | No Guidance | Provided Help of How To | |
| Validation | Information To | Market Research in | |
| Through | Market | Printer Industry to validate | |
| Influencers or | Validation and | the product | |
| Professionals | initial customer | | |
| | research | | |
| | No Access To | No Access To Marketing | |
| | Market | Agents to validate the | |
| | Research | product and initial testing | |
| | Professionals | with few customers | |
| | They Should | They can hire many | For the money |
| | have hired just | marketing agents and | spend on $150K, |
| | on marketing | size as they need | they can multiple |
| | agent specialist | 1) not only this gives them | market |
| | for full time that | multiple connections (2) it | connections and |
| | cost | also provides access to | channels instead |
| | $150K/year | initial customers from | of just one |
| | | various other channels | industry vector |
| | | | without The |
| | | | system |
| Direct Customer | Without The | Since the nature of the | (13) This saves |
| Access For | system, this | system being social, the | the consumer |
| Sales | market research | customer base readily | survey costs |
| Enablement of | and survey | available and they can do | because the |
| Consumers and | would be | 13) Talk to potential | system |
| Businesses | expensive | customers with a | connects direct |
| Direct Customer | solution. The | conversation to | potential |
| Access | product owners | understand pain points | consumers |
| | have to spend | 14) Ask questions or | who are |
| | hefty money on | surveys to customers | qualified |
| | tele marketing | whose profile closely | people to ask. |
| | surveys and | matches | (14) This saves |
| | might or might | 15) Write or Read | the market |
| | not get enough | consumer | research costs |
| | information or | reviews/stories to | (15) This also |
| | direct access | understand more | confirms that |
| | with potential | about the space | users need |
| | customers. | 16) Write skill based | unique value |
| | | actionable guides to | proposition |
| | | explain pain points | because they |
| | | without product ABC | are directly |
| | | | dealing with |
| | | | customers |
| | | | (16) Access to |
| | | | the customer |
| | | | demographics |
| | | | of who has the |
| | | | information |
| | Without The | The system Provides the | (5) This saves the |
| | system, they | platform Sales support | viral marketing |
| | have to have | channel where customers | costs |
| | the support | can | (6) This also |
| | phone numbers | 10) Talk about the product | confirms that |
| | and support | 11) Ask questions about | users need |
| | services fully | the product | unique value |
| | implemented | 12) Read Product Stories | proposition |
| | which is | 13) Find Product How- | because they |
| | expensive. | To's | are directly |
| | | 14) Learn more about the | dealing with |
| | | product | customers |
| | | 15) Interacting Tutorials | (7) Access to the |
| | | and Videos | customer |
| | | 16) Product Guides | demographics |
| | | 17) Product Manuals | of who has the |
| | | 18) Product Tutorials | information |
| | Without The | Product Owners can write | (8) This saves |
| | system, there | up the product Guides or | product |
| | will not be | Hire influencers as | support costs |
| | social | explained above to write | for the product |
| | references and | guides. | owner |
| | influencing on | 19) Sometimes even | |
| | direct | consumers can write | |
| | consumers or | guides in some cases | |
| | business | where product | |
| | | documentation or | |
| | | manuals is not clear | |
| | | from the product | |
| | | owner or | |
| | | manufacturer. | |
| | Without The | The system as Sales | (9) These are |
| | system's Sales | Distribution Channel. It | some of the |
| | Distribution | helps you sell the printers | features that |
| | must have it | directly for consumers | the system |
| | own separate | and businesses. It acts | offers that |
| | channel and | like any consumer sales | competitors |
| | Sales Enabling | distribution channels | lack in the |
| | Platform. | since both users and | current market. |
| | Usually these | product owners are at the | |
| | partnerships | same place. | |
| | takes long time | | |
| | and need lot of | | |
| | effort to make | | |
| | every | | |
| | connection and | | |
| | deal. | | |
| | Without The | The system Provides the | (10) This saves |
| | system, they | platform Sales support | the viral |
| | have to have | channel where customers | marketing |
| | the support | can | costs |
| | phone numbers | 20) Talk about the product | (11) This also |
| | and support | 21) Ask questions about | confirms that |
| | services fully | the product | users need |
| | implemented | 22) Read Product Stories | unique value |
| | which is | 23) Find Product How- | proposition |
| | expensive. | To's | because they |
| | | 24) Learn more about the | are directly |
| | | product | dealing with |
| | | 25) Interacting Tutorials | customers |
| | | and Videos | (12) Access to |
| | | 26) Product Guides | the customer |
| | | 27) Product Manuals | demographics |
| | | 28) Product Tutorials | of who has the |
| | | | information |

### Example 5

1. ABC INC. has successfully sold the ABC INC's 3D printer samples and prototypes 10 customers. Now, ABC INC. want to develop the full-blown product development with all the inputs that have taken from these initial 10 customers.
   a. It provides guidance in developing hardware products and scale the manufacturing unit that meets the market demand based on the steps 4 and 5 validation.
   b. It connects with professional engineer David, The Hardware Engineering Director, who works independently and wrote the above guidance page and Helps building hardware manufacturing units. He also takes up more private guidance
   c. It also connects with other similar Professionals who can develop the hardware prototypes into products
   d. If ABC INC. tries to do something different other than product development, like outsourcing to India or China right away, the system would have connected it with someone else like hardware engineer who knows how to outsource massive scalable hardware products like printers
2. The system also helps the ABC INC. to get started on marketing full page
   a. The system gathers all the data that it has successfully acquired customers in step 4 and 5.
   b. The system runs the data patterns of how the product is being successfully sold on demographics, people interests, and their bios.
   c. It takes this formula and applies to provide guidance and connect with more influencers, bloggers and customers
   d. It updates automatically with all the influencing parameters such as bloggers reviews on product home page or landing page with the updates directly from the system. This is the automated way where product owners save money without spending massive advertisement budgets on Google and Facebook. This also saves IT costs for the ABC Inc.
   e. If ABC Inc. selects something other than printer, the system connects the profiles that is related to the selected industry/interest/goal. And The market reports and decision parameters changes accordingly.
   f. If ABC Inc. selects non-consumer based products, then the system add additional dimension to the matrix that whoever Business Customers and their respective representatives
3. The system also helps finally with full sales pipelines. ABC Inc. can support directly on the system. The data gathered from marketing team in steps 4, 5, 6, 7 can be processed to identify the sales triggers along with the feedback received in step 8.
   a. The system saves the customer profile who bought the printer and keeps the relationship and retention value life time. This is huge cost saving for the ABC Inc. otherwise ABC Inc. would have spent lot of time and money to save all customer profiles in their databases.
   b. It helps connecting other sales representatives for these users to sell the product
   c. If ABC Inc. selects something other than printer, the system connects the profiles that is related to the selected industry/interest/goal. And The market reports and decision parameters changes accordingly.
   d. If ABC Inc. selects non-consumer based products, then the system add additional dimension to the matrix that whoever Business Customers and their respective representatives.

### Example 6

| Comparing Feature | Problem | The system Solution | Cost Comparison |
|---|---|---|---|
| Developing | No Guidance | Clear Guidance | This guidance |
| Hardware | Information. | Provided How To | costs little upfront |
| Printer | | Develop Hardware | money to save |
| | | Printer Prototype | thousands of |
| | | | dollars to follow |
| | | | best practices and |
| | | | to avoid any |
| | | | pitfalls of ideation |
| | | | phase of the |
| | | | company |
| | No access to market | They can even Hire | This professional |
| | influencing designers | Professionals to | guidance costs |
| | to provide guidance | GET private | little upfront |
| | | guidance | money to save |
| | | | thousands of |
| | | | dollars to follow |
| | | | best practices and |
| | | | to avoid any |
| | | | pitfalls of ideation |
| | | | phase of the |
| | | | company |
| | They Should have | They can hire as | For the money |
| | hired just on | many as prototype | spend on $105K, |
| | prototype specialist | developers and size | they can multiple |
| | for full time that cost | as they need | prototypes instead |
| | $105K/year | | of just one |
| | | | prototype without |
| | | | The system |
| Market Access | No Guidance | Provided Help of | |
| To Customers | Information To | How To Market | |
| Through | Market Validation | Research in Printer | |
| Influencers or | and initial customer | Industry to validate | |
| Professionals | research | the product | |
| | No Access To Market | No Access To | |
| | Research | Marketing Agents to | |
| | Professionals | validate the product | |
| | | and initial testing | |
| | | with few customers | |
| | They Should have | They can hire many | For the money |
| | hired just on | marketing agents | spend on $150K, |
| | marketing agent | and size as they | they can multiple |
| | specialist for full time | need | market |
| | that cost $150K/year | 1) not only this gives | connections and |
| | | them multiple | channels instead |
| | | connections (2) it | of just one |
| | | also provides | industry vector |
| | | access to initial | without The |
| | | customers from | system |
| | | various other | |
| | | channels | |
| Influential | 1) The system | These are some of | Influential |
| Marketing | connects your | the features that the | Marketing cannot |
| cannot be done | product for | system offers that | be done without |
| without The | various | competitors lack in | The system |
| system | influencers who | the current market. | |
| | would like talk | | |
| | about printers | | |
| | who has followers | | |
| | 2) The system also | | |
| | connects other | | |
| | influencers like | | |
| | who are writing | | |
| | about toddler's | | |
| | DIY projects with | | |
| | the new printer. | | |
| | This would never | | |
| | happen without | | |
| | The system, | | |
| | 3) The system | | |
| | recommends the | | |
| | printer for the | | |
| | home decoration | | |
| | influencers as | | |
| | well if the printer | | |
| | brings enough | | |
| | charm to the | | |
| | living room. | | |
| Direct Customer | Without The system, | Since the nature of | (17) This saves |
| Access For | this market research | the system being | the consumer |
| Sales | and survey would be | social, the customer | survey costs |
| Enablement of | expensive solution. | base readily | because the |
| Consumers and | The product owners | available and they | system |
| Businesses | have to spend hefty | can do | connects direct |
| Direct Customer | money on tele | 17) Talk to potential | potential |
| Access | marketing surveys | customers with a | consumers |
| | and might or might | conversations to | who are |
| | not get enough | understand pain | qualified |
| | information or direct | points | people to ask. |
| | access with potential | 18) Ask questions or | (18) This saves |
| | customers. | surveys to | the market |
| | | customers | research costs |
| | | whose profile | (19) This also |
| | | closely matches | confirms that |
| | | 19) Write or Read | users need |
| | | consumer | unique value |
| | | reviews/stories to | proposition |
| | | understand more | because they |
| | | about the space | are directly |
| | | 20) Write skill based | dealing with |
| | | actionable | customers |
| | | guides to explain | (20) Access to |
| | | pain points | the customer |
| | | without product | demographics |
| | | ABC | of who has the |
| | | | information |
| | Without The system, | The system | (13) This saves |
| | they have to have the | Provides the | the viral |
| | support phone | platform Sales | marketing |
| | numbers and support | support channel | costs |
| | services fully | where customers | (14) This also |
| | implemented which is | can | confirms that |
| | expensive. | 29) Talk about the | users need |
| | | product | unique value |
| | | 30) Ask questions | proposition |
| | | about the | because they |
| | | product | are directly |
| | | 31) Read Product | dealing with |
| | | Stories | customers |
| | | 32) Find Product | (15) Access to |
| | | How-To's | the customer |
| | | 33) Learn more | demographics |
| | | about the | of who has the |
| | | product | information |
| | | 34) Interacting | |
| | | Tutorials and | |
| | | Videos | |
| | | 35) Product Guides | |
| | | 36) Product Manuals | |
| | | 37) Product Tutorials | |
| | Without The system, | Product Owners can | (16) This saves |
| | there will not be | write up the product | product |
| | social references and | Guides or Hire | support costs |
| | influencing on direct | influencers as | for the product |
| | consumers or | explained above to | owner |
| | business | write guides. | |
| | | 38) Sometimes even | |
| | | consumers can | |
| | | write guides in | |
| | | some cases | |
| | | where product | |
| | | documentation or | |
| | | manuals is not | |
| | | clear from the | |
| | | product owner or | |
| | | manufacturer. | |
| | Without The system | The system as | (17) These are |
| | Sales Distribution | Sales Distribution | some of the |
| | must have it own | Channel. It helps | features that |
| | separate channel | you sell the printers | the system |
| | and Sales Enabling | directly for | offers that |
| | Platform. Usually | consumers and | competitors |
| | these partnerships | businesses. It acts | lack in the |
| | takes long time and | like any consumer | current market. |
| | need lot of effort to | sales distribution | |
| | make every | channels since both | |
| | connection and deal. | users and product | |
| | | owners are at the | |
| | | same place. | |

### Example 7

1. ABC INC. has successfully automated the product development process. Now, it has to drive sales and marketing
   a. It provides guidance in growth hacking the sales and marketing hardware products to create and tap the market
   b. It connects with professional marketing team David who writes the blog, The Hardware Marketing Agency, who works independently and wrote the above guidance page and Helps building hardware manufacturing units. He also takes up more private guidance
   c. It also connects with other similar Professionals who can do sales and marketing of hardware printers
   d. If ABC Inc. selects something other than printer, the system connects the profiles that is related to the selected industry/interest/goal. And The market reports and decision parameters changes accordingly.
   e. If ABC Inc. selects non consumer based products, then The system add additional dimension to the matrix that whoever Business Customers and their respective representatives
2. The system also helps the ABC INC. to get started with sales deals with business customers who needs 3D printers
   a. The system has the data how it has successfully acquired customers in step 1 thru 9.
   b. The system runs the data patterns of how the product is being successfully sold on demographics, people interests, and their bios.
   c. It takes this formula and applies to business who are operating with these customers and it finds the bloggers who work with these types of companies
   d. It connects these companies through influencers or bloggers reviews directly from the system. This is the automated way where product owners save money without spending massive marketing budgets and IT budgets.
   e. If ABC Inc. selects something other than printer, the system connects the profiles that is related to the selected industry/interest/goal. And The market reports and decision parameters changes accordingly.
   f. If ABC Inc. selects non-consumer based products, then The system add additional dimension to the matrix that whoever Business Customers and their respective representatives
3. The system also helps the ABC INC. to get started with sales deals with consumers who needs 3D printers
   a. The system has the data how it has successfully acquired customers in step 1 thru 9.
   b. The system runs the data patterns of how the product is being successfully sold on demographics, people interests, and their bios.
   c. It takes this formula and applies to consumers whose interests matches with these customers
   d. it finds the respective bloggers who work with these types of consumers
   e. It connects these consumers through influencers or bloggers reviews directly from the system. This is the automated way where product owners save money without spending massive advertising budgets and IT budgets.
   f. If ABC Inc. selects something other than printer; the system connects the profiles that are related to the selected industry/interest/goal. And The market reports and decision parameters changes accordingly.
   g. If ABC Inc. selects non-consumer based products, then the system add additional dimension to the matrix that whoever Business Customers and their respective representatives.

### Example 8

| Comparing Feature | Problem | The system Solution | Cost Comparison |
|---|---|---|---|
| Developing | No Guidance | Clear Guidance | This guidance |
| Hardware | Information. | Provided How To Sell | costs little upfront |
| Printer | | and scale Print | money to save |
| | | Industry | thousands of |
| | | | dollars to follow |
| | | | best practices and |
| | | | to avoid any |
| | | | pitfalls of ideation |
| | | | phase of the |
| | | | company |
| | No access to market | They can even Hire | This professional |
| | influencing designers | Professionals to GET | guidance costs |
| | to Print Industry | private guidance | little upfront |
| | | | money to save |
| | | | thousands of |
| | | | dollars to follow |
| | | | best practices and |
| | | | to avoid any |
| | | | pitfalls of ideation |
| | | | phase of the |
| | | | company |
| | They Should have | They can hire as | For the money |
| | hired just on one or | minimal as they need | spend on $105K, |
| | two team members | and size and scale | they can multiple |
| | for full time that cost | based on market | prototypes, |
| | $105K/year | demand | multiple |
| | | | developers, faster |
| | | | and easier way to |
| | | | develop printers |
| | | | instead of just one |
| | | | team member |
| | | | without The |
| | | | system |
| Market Access | No Guidance | Provided Help of How | |
| To Customers | Information To | To Market Research | |
| Through | Market Validation | in Printer Industry to | |
| Influencers or | and initial customer | validate the product | |
| Professionals | research | | |
| | Market Research | No Access To | |
| | Professionals or | Marketing Agents to | |
| | Marketing Agency | validate the product | |
| | must be separately | and initial testing with | |
| | hired. | few customers | |
| | They Should have | They can hire many | For the money |
| | hired just on | marketing agents and | spend on $150K, |
| | marketing agent | size as they need | they can multiple |
| | specialist for full time | 1) not only this gives | market |
| | that cost $150K/year | them multiple | connections and |
| | | connections (2) it also | channels instead |
| | | provides access to | of just one |
| | | initial customers from | industry vertical |
| | | various other | without The |
| | | channels | system |
| | Influential Marketing | 4) The system | These are some |
| | cannot be done | connects your | of the features |
| | without The system | product for various | that the system |
| | | influencers who | offers that |
| | | would like talk | competitors lack |
| | | about printers who | in the current |
| | | has followers | market. |
| | | 5) The system also | |
| | | connects other | |
| | | influencers like | |
| | | who are writing | |
| | | about toddler's | |
| | | DIY projects with | |
| | | the new printer. | |
| | | This would never | |
| | | happen without | |
| | | The system, | |
| | | 6) The system | |
| | | recommends the | |
| | | printer for the | |
| | | home decoration | |
| | | influencers as well | |
| | | if the printer brings | |
| | | enough charm to | |
| | | the living room. | |
| | There is no marking | 1) The product | These are some |
| | automation process | marketing web | of the features |
| | exist without the | page automatically | that the system |
| | system. | or semi- | offers that |
| | | automatically | competitors lack |
| | | updated with how | in the current |
| | | many influencers | market. |
| | | talking about the | |
| | | product and how | |
| | | many are | |
| | | influenced | |
| | | (typically the | |
| | | marketing page | |
| | | also known as | |
| | | product landing | |
| | | page) | |
| | | 2) When someone | |
| | | got influenced by | |
| | | the influencers the | |
| | | marketing page | |
| | | also tracks the | |
| | | relationship of | |
| | | logged in | |
| | | customer with both | |
| | | influencer and | |
| | | influenced person | |
| | | any friend or | |
| | | follower or family | |
| | | member or they | |
| | | have a group in | |
| | | common so that it | |
| | | would be more | |
| | | attractive for the | |
| | | customer. | |
| Direct | Without The system, | Since the nature of | (21) This saves |
| Customer | this market research | the system being | the consumer |
| Access For | and survey would be | social, the customer | survey costs |
| Sales | expensive solution. | base readily available | because the |
| Enablement of | The product owners | and they can do | system |
| Consumers | have to spend hefty | 21) Talk to potential | connects direct |
| and | money on tele | customers with a | potential |
| Businesses | marketing surveys | conversations to | consumers |
| Direct | and might or might | understand pain | who are |
| Customer | not get enough | points | qualified |
| Access | information or direct | 22) Ask questions or | people to ask. |
| | access with potential | surveys to | (22) This saves |
| | customers. | customers whose | the market |
| | | profile closely | research costs |
| | | matches | (23) This also |
| | | 23) Write or Read | confirms that |
| | | consumer | users need |
| | | reviews/stories to | unique value |
| | | understand more | proposition |
| | | about the space | because they |
| | | 24) Write skill based | are directly |
| | | actionable guides | dealing with |
| | | to explain pain | customers |
| | | points without | (24) Access to |
| | | product ABC | the customer |
| | | | demographics |
| | | | of who has the |
| | | | information |
| | Without The system, | The system Provides | (18) This saves |
| | they have to have the | the platform Sales | the viral |
| | support phone | support channel | marketing |
| | numbers and support | where customers can | costs |
| | services fully | 1) Talk about the | (19) This also |
| | implemented which is | product | confirms that |
| | expensive. | 2) Ask questions | users need |
| | | about the product | unique value |
| | | 3) Read Product | proposition |
| | | Stories | because they |
| | | 4) Find Product How- | are directly |
| | | To's | dealing with |
| | | 5) Learn more about | customers |
| | | the product | (20) Access to |
| | | 6) Interacting | the customer |
| | | Tutorials and | demographics |
| | | Videos | of who has the |
| | | 7) Product Guides | information |
| | | 8) Product Manuals | |
| | | 9) Product Tutorials | |
| | Without The system, | Product Owners can | (21) This saves |
| | there will not be | write up the product | product |
| | social references and | Guides or Hire | support costs |
| | influencing on direct | influencers as | for the product |
| | consumers or | explained above to | owner |
| | business | write guides. | |
| | | Or Sometimes even | |
| | | consumers can write | |
| | | guides in some cases | |
| | | where product | |
| | | documentation or | |
| | | manuals is not clear | |
| | | from the product | |
| | | owner or | |
| | | manufacturer. | |

### Example 9

1. ABC Inc. has successfully SOLD the printer with the help of Guidance and professional resources from
2. The system has the data how it has successfully acquired customers in step 1 through 12.
3. The system runs the data patterns of how the product is being successfully sold on demographics, people interests, and their bios.
4. It takes this formula and applies to consumers whose interests matches with these customers and provides back to ABC Inc. for further finding market gaps
5. The system provides guidance from growth hackers and product pipeline designers to help ABC Inc. for their next printer
6. It connects these influencers or bloggers directly from the system. This is the automated way where product owners save money without spending massive consulting budgets to design the next product in pipeline.
7. If ABC Inc. selects something other than printer, the system connects the profiles that is related to the selected industry/interest/goal. And The market reports and decision parameters changes accordingly.
8. If ABC Inc. selects non-consumer based products, then The system add additional dimension to the matrix that whoever Business Customers and their respective representatives

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method may be made while retaining the teachings of the present invention.

What is claimed is:

1. A computer implemented method of identifying compatible content to a user, using a user device, with one or more processors and a memory, in communication with a network, the method comprising:
identifying, with an aggregation module in communication with the one or more processors, user interest wherein the user interest indicates a topic of interest by a user;
searching, with a search module in communication with the one or more processors, a database for a plurality of contents associated with the user interest, the plurality of contents being provided by multiple content providers;
identifying, with a match analysis module in communication with the one or more processors, attributes of each of the multiple content providers;
associating, with the match analysis module, each of the plurality of contents with attributes corresponding to each of the multiple content providers;
comparing, with the match analysis module, the user interest with the attributes;
determining, with the match analysis module, a compatibility between the user interest and the attributes based on a predetermined interest-to-attribute relation stored in the database; and
recommending, with a recommendation module in communication with the one or more processors, to the user via the user device, one or more of the plurality of contents based on the compatibility.

2. The method of claim 1, wherein the multiple content providers comprise a merchant user group and a guidance provider user group.

3. The method of claim 1, wherein the attributes comprise occupation, expertise, and experience level.

4. The method of claim 1 further comprising the step of determining, with the match analysis module, a compatibility between the user interest and interests of the multiple content provider.

5. The method of claim 1 further comprising the step of receiving, with the user device, inputs from the user, wherein the inputs comprise the user interest.

6. A system, using a user device in communication with a network, that identifies compatible content to a user, comprising:
a user device, with one or more processors and a memory, each having a computerized user interface, wherein the user device receives inputs from a user;
an aggregation module, in communication with the one or more processors, identifying user interest wherein the user interest indicates a topic of interest by the user;
a search module, in communication with the one or more processors, searching a database for a plurality of contents associated with the user interest, the plurality of contents being provided by multiple content providers; and
a match analysis module in communication with the one or more processors, configured to:
identify attributes of each of the multiple content providers;
associate each of the plurality of contents with attributes corresponding to each of the multiple content providers;
compare the user interest with the attributes; and
determine a compatibility between the user interest and the attributes based on a predetermined interest-to-attribute relation stored in the database.

7. The system of claim 6, wherein the multiple content providers comprise a merchant user group and a guidance provider user group.

8. The system of claim 6, wherein the attributes comprise occupation, expertise, and experience level.

9. The system of claim 6 wherein the match analysis module is further configured to determine a compatibility between the user interest and interests of the multiple content provider.

10. The system of claim 6 wherein the inputs comprise the user interest.

11. A computer implemented method of identifying compatible combination of multiple contents to a user, using a user device, with one or more processors and a memory, in communication with a network, the multiple contents being provided by a merchant user group and a guidance provider user group, the method comprising:
identifying, with an aggregation module in communication with the one or more processors, user interest wherein the user interest indicates a topic of interest by a user;
searching, with a search module in communication with the one or more processors, a database for a plurality of contents associated with the user interest, the plurality of contents being provided by the merchant user group and the guidance provider user group, wherein the merchant user group provides contents related to products being offered by the merchant user group and the guidance provider user group provides instructive material;
identifying, with a match analysis module in communication with the one or more processors, attributes of the merchant user group and the guidance provider user group;
associating, with the match analysis module, each of the plurality of contents with attributes and type of the user groups;
comparing, with the match analysis module, the user interest with the attributes of the guidance provider user group;
determining, with the match analysis module, a compatibility between the user interest and the attributes of the guidance provider user group based on a predetermined interest-to-attribute relation stored in the database;
determining, with the match analysis module, a compatibility between contents being provided by the guidance provider user group and the merchant user group by comparing attributes of each of the user groups; and
recommending, with a recommendation module in communication with the one or more processors, to the user via the user device, one or more of the plurality of contents provided by the guidance provider user group and one or more of the plurality of contents provided by the merchant user group based on the compatibilities.

12. The method of claim 11, wherein the multiple content providers comprise a merchant user group and a guidance provider user group.

13. The method of claim 11, wherein the attributes comprise occupation, expertise, and experience level.
